(19) United States
(12) Patent Application Publication
(10) Pub. No.: US 2008/0284998 A1
(43) Pub. Date: Nov. 20, 2008

(54) LITHOGRAPHIC APPARATUS AND METHOD OF CONTROLLING

(75) Inventors: Bernd Geh, Scottsdale, AZ (US); Erik Roelof Loopstra, Heeze (NL); Donis Flagello, Scottsdale, AZ (US)

Correspondence Address: JONES DAY, 222 EAST 41ST ST, NEW YORK, NY, 10017, US

(73) Assignees: CARL ZEISS SMT AG, Oberkochen (DE); ASML NETHERLANDS B.V., Veldhoven (NL)

(21) Appl. No.: 12/061,339

(22) Filed: Apr. 2, 2008

Related U.S. Application Data
(63) Continuation of application No. PCT/EP2006/009553, filed on Oct. 2, 2006.
(60) Provisional application No. 60/722,981, filed on Oct. 4, 2005.

(51) Int. Cl. G03B 27/42; G03B 27/72

(52) U.S. Cl. 355/53; 355/71

(57) ABSTRACT

A system and method for controlling exposure in a lithographic apparatus are disclosed. The system can have adjustable optical elements capable of being decentered to adjust an illumination distribution. Embodiments include a lithographic apparatus structure configured to allow for spatial dose control, for example as a function of X and Y in response to spatial variation in polarization state and birefringence of optical components of the lithographic system.

### CROSS-REFERENCE TO RELATED APPLICATIONS

This application is a continuation application of International Application Serial No. PCT/EP2006/009553, filed on Oct. 2, 2006, which claims benefit to U.S. Provisional Application No. 60/722,981, filed Oct. 4, 2005. The contents of PCT/EP2006/009553 are hereby incorporated by reference.

### TECHNICAL FIELD

The present disclosure relates to lithographic apparatus and methods.

### BACKGROUND

A lithographic apparatus is a machine that can apply a desired pattern onto a target portion of a substrate. Lithographic apparatus can be used, for example, in the manufacture of integrated circuits (ICs). In that circumstance, a patterning device, such as a mask, may be used to generate a circuit pattern corresponding to an individual layer of the IC, and this pattern can be imaged onto a target portion (e.g., including part of, one or several dies) on a substrate (e.g., a silicon wafer) that has a layer of radiation-sensitive material (resist). In general, a single substrate will contain a network of adjacent target portions that are successively exposed.

Conventional lithographic apparatus include so-called steppers, in which each target portion is irradiated by exposing an entire pattern onto the target portion at once, and so-called scanners, in which each target portion is irradiated by scanning the pattern through the beam of radiation in a given direction (the “scanning”-direction) while synchronously scanning the substrate parallel or anti-parallel to this direction.

Variations in illumination dose can lead to variations in dimensions of imaged structures. In particular, as dose is decreased, structures tend to appear somewhat thinner than intended. Likewise, increased dose can lead to structures that image wider than intended. In either case, the variation in dimension (variation in critical dimension, or CD variation) can lead to defects in the finished microelectronic devices.

### SUMMARY

The inventors have determined that, among other effects, variations in polarization state across the image field can result in a CD variation that is similar in effect to that of a change in dose.

Embodiments of the present disclosure include a lithographic projection apparatus that includes an illumination system for conditioning a projection beam of radiation, a first object table for holding a patterning device capable of patterning the projection beam according to a desired pattern, a second object table for holding a substrate, a projection system for imaging the patterned beam onto a target portion of the substrate, and a controller, configured and arranged to control a radiation dose impinging on the substrate in response to a critical dimension error, at a plane of the substrate, resulting from a spatial variation in polarization of the beam.

In some embodiments, a lithographic projection apparatus includes an illumination system for conditioning a projection beam of radiation, a first object table for holding a patterning device capable of patterning the projection beam according to a desired pattern, a second object table for holding a substrate, a projection system for imaging the patterned beam onto a target portion of the substrate, and an actuator, constructed and arranged to decenter at least one optical element of the illumination system in response to a measured critical dimension error, at a plane of the substrate, resulting from a local variation in intensity of the projection beam of radiation, prior to patterning.

### DESCRIPTION OF DRAWINGS

Embodiments of the disclosure will now be described, by way of example only, with reference to the accompanying schematic drawings in which corresponding reference symbols indicate corresponding parts, and in which:

FIG. 1 depicts a lithographic apparatus;

FIG. 2 schematically illustrates certain causes of critical dimension errors in a lithographic system;

FIG. 3 schematically illustrates another type of critical dimension error in a lithographic system;

FIG. 4 schematically illustrates a dynamic filter for correcting illumination distribution imbalances in accordance with an embodiment of the present disclosure;

FIG. 5 schematically illustrates an alternate dynamic filter for correcting illumination distribution imbalances;

FIG. 6a and FIG. 6b illustrate a method of varying dose; and

FIG. 7a and FIG. 7b illustrate a model CD variation map based on a measured mask birefringence.

### DETAILED DESCRIPTION

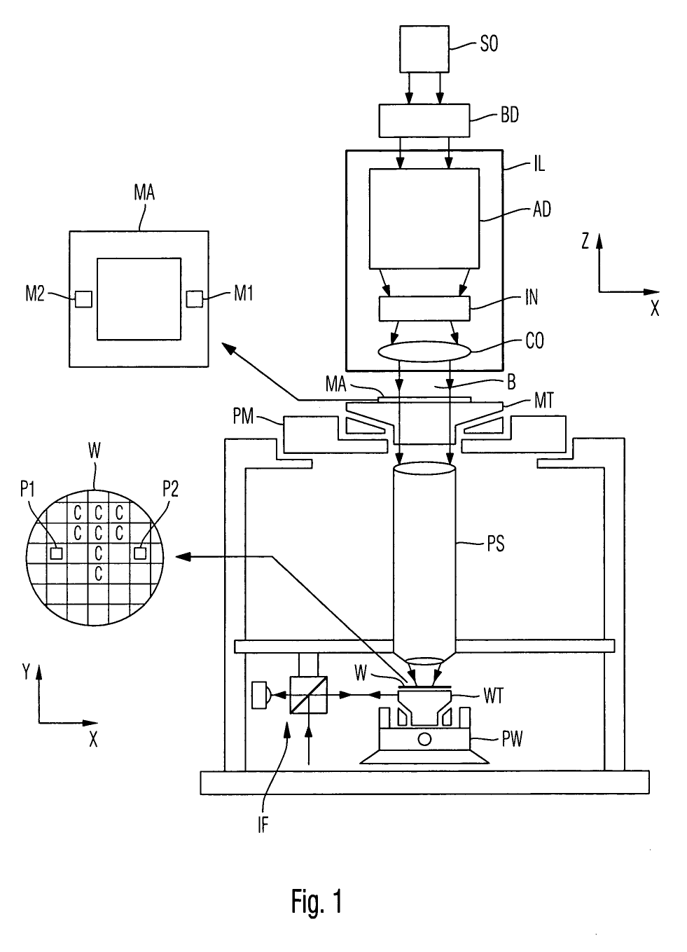

FIG. 1 schematically depicts a lithographic apparatus according to an embodiment of the disclosure. The apparatus includes an illumination system (illuminator) IL configured to provide a beam B of radiation (e.g. UV radiation) and a first support structure (e.g. a mask table) MT configured to support a patterning device (e.g. a mask) MA and connected to a first positioning device PM configured to accurately position the patterning device with respect to the projection system (“lens”), item PS. The apparatus also includes a substrate table (e.g., a wafer table) WT configured to hold a substrate (e.g., a resist-coated wafer) W and connected to a second positioning device PW configured to accurately position the substrate with respect to the projection system (“lens”), item PS, the projection system (e.g., a refractive projection lens) PS being configured to image a pattern imparted to the beam of radiation B by patterning device MA onto a target portion C (e.g., including one or more dies) of the substrate W.

As here depicted, the apparatus is of a transmissive type (e.g., employing a transmissive mask). Alternatively, the apparatus may be of a reflective type (e.g., employing a programmable mirror array of a type as referred to above).

The illuminator IL receives a beam of radiation from a radiation source SO. The source and the lithographic apparatus may be separate entities, for example when the source is an excimer laser. In such cases, the source is not considered to form part of the lithographic apparatus and the radiation beam is passed from the source SO to the illuminator IL with the aid of a beam delivery system BD including for example suitable directing mirrors and/or a beam expander. In other cases the source may be integral part of the apparatus, for example when the source is a mercury lamp. The source SO and the illuminator IL, together with the beam delivery system BD if required, may be referred to as a radiation system.

The illuminator IL conditions the radiation beam B. The illuminator IL may include an adjusting device AD configured to adjust the angular intensity distribution of the beam. Generally, at least the outer and/or inner radial extent (commonly referred to as R-outer and W-inner, respectively) of the intensity distribution in a pupil plane of the illuminator can be adjusted. In addition, the illuminator IL generally includes various other components, such as an integrator IN and a condenser CO. The illuminator provides a conditioned beam of radiation, referred to as the beam of radiation B, having a desired uniformity and intensity distribution in its cross-section.

The beam of radiation B is incident on the mask MA, which is held on the mask table MT. Having traversed the mask MA, the beam of radiation B passes through the projection system (“lens”) PS, which focuses the beam onto a target portion C of the substrate W. With the aid of the second positioning device PW and position sensor IF (e.g., an interferometric device), the substrate table or substrate support WT can be moved accurately, e.g., so as to position different target portions C in the path of the beam B. Similarly, the first positioning device PM and another position sensor (which is not explicitly depicted in FIG. 1) can be used to accurately position the mask MA with respect to the path of the beam B, e.g., after mechanical retrieval from a mask library, or during a scan. In general, movement of the object tables MT and WT will be realized with the aid of a long-stroke module (coarse positioning) and a short-stroke module (fine positioning), which form part of the positioning devices PM and PW. However, in the case of a stepper (as opposed to a scanner) the mask table MT may be connected to a short stroke actuator only, or may be fixed. Mask MA and substrate W may be aligned using mask alignment marks M1, M2 and substrate alignment marks P1, P2.

The depicted apparatus can be used in the following modes:

Step mode: the mask table or pattern support MT and the substrate table or substrate support WT are kept essentially stationary, while an entire pattern imparted to the beam of radiation is projected onto a target portion C at once (i.e., a single static exposure). The substrate table or substrate support WT is then shifted in the X and/or Y direction so that a different target portion C can be exposed. In step mode, the maximum size of the exposure field limits the size of the target portion C imaged in a single static exposure.

Scan mode: the mask table or pattern support MT and the substrate table or substrate support WT are scanned synchronously while a pattern imparted to the beam of radiation is projected onto a target portion C (i.e., a single dynamic exposure). The velocity and direction of the substrate table or substrate support WT relative to the mask table MT is determined by the (de-)magnification and image reversal characteristics of the projection system PS. In scan mode, the maximum size of the exposure field limits the width (in the non-scanning direction) of the target portion in a single dynamic exposure, whereas the length of the scanning motion determines the height (in the scanning direction) of the target portion.

Another mode: the mask table or pattern support MT is kept essentially stationary holding a programmable patterning device, and the substrate table or substrate support WT is moved or scanned while a pattern imparted to the beam of radiation is projected onto a target portion C. In this mode, generally a pulsed radiation source is employed and the programmable patterning device is updated as required after each movement of the substrate table or substrate support WT or in between successive radiation pulses during a scan. This mode of operation can be readily applied to maskless lithography that utilizes a programmable patterning device, such as a programmable mirror array of a type as referred to above.

Combinations and/or variations on the above described modes of use or entirely different modes of use may also be employed.

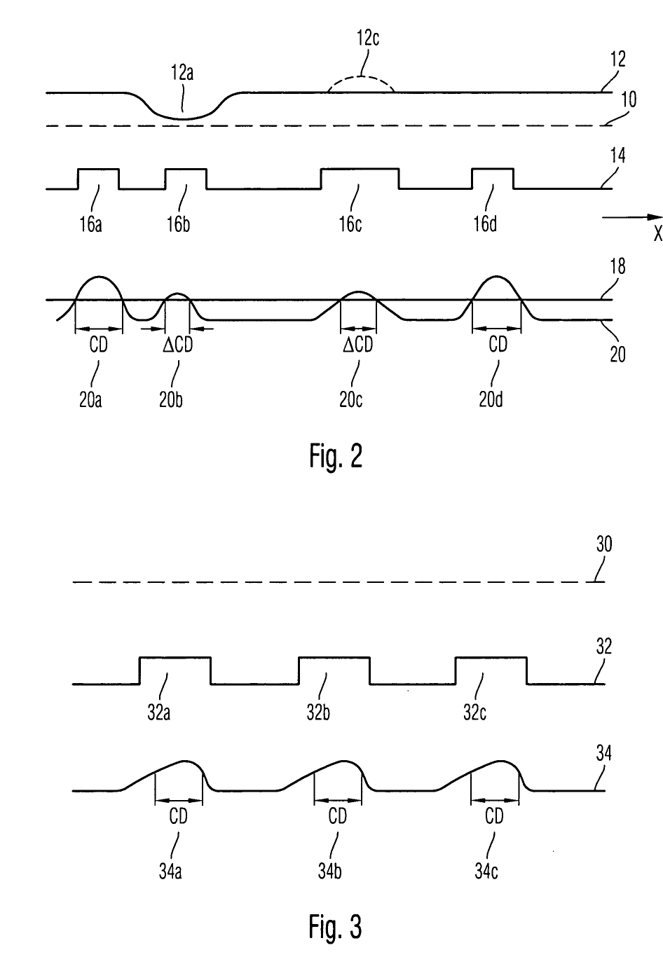

FIG. 2 is a schematic illustration of certain causes of critical dimension errors in imaging. As seen in FIG. 2, an ideal dose distribution 10 would be perfectly flat, representing even dosage throughout a region of the wafer. In reality, the dosage will generally have certain variations and be uneven as is the dose distribution 12. A local reduction in dose 12a represents a portion of the wafer region that receives a reduced dose. The maps shown in FIG. 2 are taken to be in the X direction, where Z is the vertical direction, Y is the scan direction, and X is perpendicular to the scan direction. Only the direction X is shown in the figure.

A mask 14 contains a number of features 16a-d. Each of these mask features is imaged onto the resist layer 18, thereby exposing the resist as illustrated schematically by the line 20. At 20a, the feature 16a is imaged. Because the dose is correct and homogeneous, and because there is no other source of error, the feature 16a is correctly imaged at 20a. Because the feature is correctly imaged, there is no error ACD, and the feature is equal to the critical dimension. Likewise, feature 16d is correctly imaged at 20d, and the width is equal to the critical dimension.

As noted above, there is a local dose gradient 12a that is located at the position of the feature 16b. Thus, at 20b, where 16b is imaged, there is an error in critical dimension, ACD. In this case, we assume that there is no other effect on imaging than the one caused by the variation in dose. In such a case, dose can be measured as a function of X and Y positions of the wafer and mask. Therefore, in order to correct such an error, dose variation may be mapped, and a correction can be applied to the dose distribution in order to properly image the structure 16b onto the wafer.

Moving on to the feature 16c, there is no apparent error in dose at source, that is the line 12 is locally homogeneous at the point where the feature 16c is illuminated. However, 20c shows a variation ACD. In this case, we can surmise that there is an error that is not invariant for dose (X,Y) as was the error at 16b, 20b. As described above, this may be caused, for example, by the instrinsic birefringence of the mask 14, particularly where the illumination light has a strong polarization component. On the other hand, it may also occur due to birefringence in one or more components of the imaging system (not shown in FIG. 2). Correction of this type of error may be achieved, for example, by local dose correction, as represented by the dashed lines 12c.

Another imaging effect that can result in CD error despite proper dose is illustrated in FIG. 3. FIG. 3 shows a system having a consistent dose 30 at the pupil plane. However, the illumination distribution in this case is taken to be a dipole having intensity differences between the two poles. For such unbalanced poles, the image 34 of the features 32a-c will tend to take on a saw-tooth shape as illustrated at 34a-c. Assuming all else is equal, the image dimension for each of the features 34a-c will have equal errors ΔCD. That is, for equal features 32a-c, each saw-tooth image 34a-c will have a width that is substantially the same error relative to its desired width.

Furthermore, the centerline of each imaged feature will be offset from its intended target, introducing some potential overlay error.

One solution to such an error is to introduce a structure to attenuate the energy from the stronger of the two poles. In accordance with an embodiment of the present disclosure, such attenuation may be produced, for example, by decentering optical elements of the system. In particular, optical elements of the illumination system may be decentered in order to better balance the illumination distribution. As will be appreciated, similar effects can result in a quadrupole illumination pattern, where the four poles are not precisely balanced. Likewise, the concept may be extended to other illumination patterns.

Decentration of the optical elements may be achieved either by XY manipulation of the lens elements, i.e., physically moving one or more element from its centered position, or by introducing a tilt to one or more elements. As will be appreciated, such manipulations apply equally to refractive and to reflective optical systems.

A dose map and/or a polarization map may be prepared for a given machine or for a given process. Such a map may be used as the basis for a corrective algorithm including the decentration approach described above for local illumination intensity variation, or for the dose control approach described for polarization induced CD variation.

In the case that birefringence of the reticle is at issue, a reticle birefringence map may be produced that is stored as part of a recipe for controlling a lithographic apparatus for a process using that reticle. Actual structures imaged in resist may be measured to produce such a recipe. As an alternative, for systems employing pupil mapping sensors, the illumination distribution at the pupil may be directly measured, either in real time, or as a preliminary characterization of the system and process.

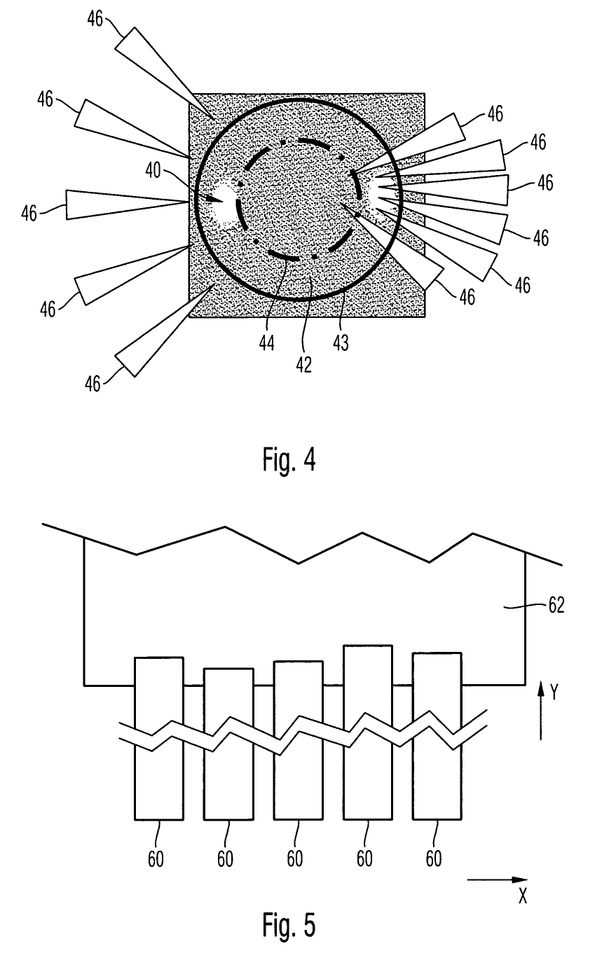

FIG. 4 illustrates one technique for correcting local variation of intensity in the illumination beam using a combination of decentration and local filtering. In FIG. 4, two poles 40, 42, in an illumination field 43 initially are unequal, with pole 42 having a somewhat greater intensity. A decentration of an optical element (schematically illustrated by the dashed line 44) is used to affect the internal radii of the poles 42, 44. A number of spokes 46, arranged around the outer radius of the field 43 are movable into and out of the field to attenuate the illumination light. The spokes may be, for example, fully or partially opaque. As shown in FIG. 4, a number of spokes 46 on the right hand side are inserted into a field plane and reduce the intensity of the pole 42. This filtering may take place physically at the pupil plane of the illumination system, or be performed in a plane that is optically conjugate that plane, or at least proximate such a plane.

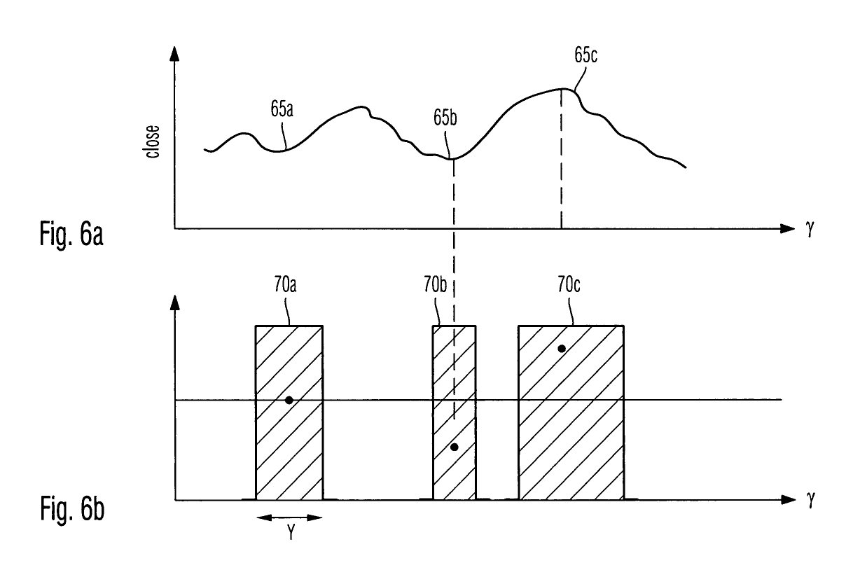

FIG. 5 shows an embodiment of a controllable filter made up of a series of fingers 60. Each finger 60 is controllable in the Y direction and has a transmittance for the illumination radiation that is less than 100%. By varying the Y position of the fingers 60 relative to the scanning region 62, more or less light can be allowed to pass through to provide imaging. As a result, dose as a function of X can be controlled. Furthermore, if the position of the fingers is dynamically controlled during the scan, then dose in Y can also be controlled. By providing fingers 60 on each edge of the scanning region, i.e., mirroring FIG. 6 about the scan axis, both edges of the region can be controlled independently.

In another embodiment, the scanning slit may be varied in width. As is evident, a pair of fingers set on either edge of the scan region can be used to achieve this result. Likewise, slit masking blades could be employed for the same purpose. Varying the width of the illuminated scan region dynamically during a scan would allow for dose control as a function of Y, as illustrated in FIGS. 6a and 6b. For three example Y positions, the slit width 70a-c shown in FIG. 6b results in respective doses 65a-c as shown in FIG. 6a. In particular, where the slit is wider at 70c, the corresponding dose 65c is larger.

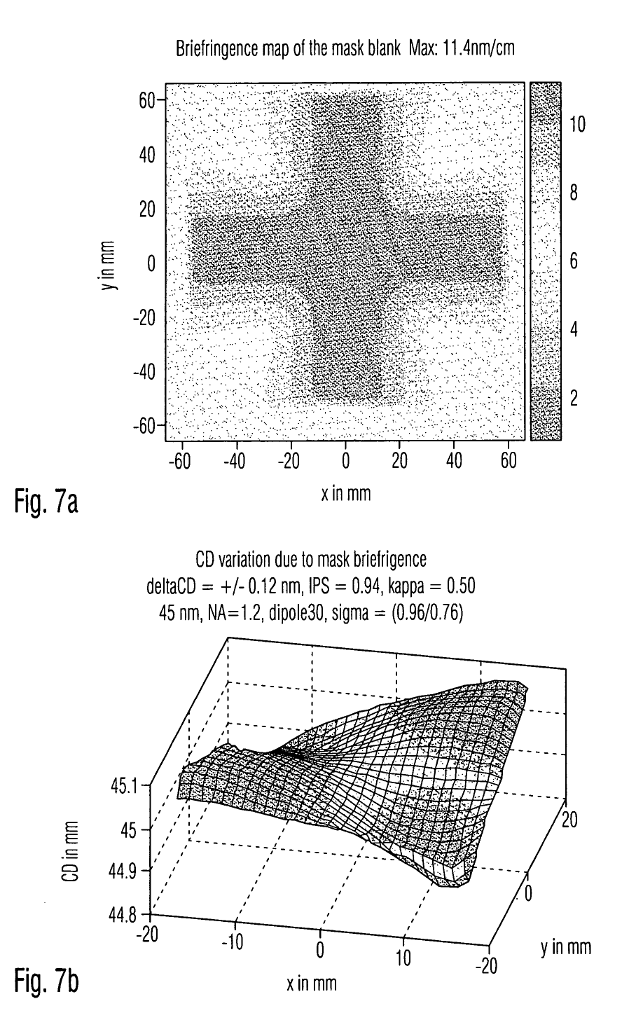

FIGS. 7a and 7b illustrate a model CD variation map based on a measured mask birefringence. In FIG. 7a, the birefringence of the mask is shown, while FIG. 7b shows a CD variation map in X and Y. As can be seen, the CD variation is saddle-like, with the (+,−) quadrant and the (−,+) quadrant showing a reduction in critical dimension while the (−,−) and (+,+) quadrants show an increase. In case the polarized light is slightly elliptical, manipulation of the handedness (right handed circular or left handed circular) of the elliptical polarization can allow for another solution. By reversing the handedness for the positive X portion of the mask, the saddle becomes closer to an inclined plane. Such a tilted CD variation can be corrected using known methods.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, liquid-crystal displays (LCDs), thin-film magnetic heads, etc. The skilled artisan will appreciate that, in the context of such alternative applications, any use of the terms “wafer” or “die” herein may be considered as synonymous with the more general terms “substrate” or “target portion,” respectively. The substrate referred to herein may be processed, before or after exposure, in for example a track (a tool that typically applies a layer of resist to a substrate and develops the exposed resist) or a metrology or inspection tool. Where applicable, the disclosure herein may be applied to such and other substrate processing tools. Further, the substrate may be processed more than once, for example in order to create a multi-layer IC, so that the term substrate used herein may also refer to a substrate that already contains multiple processed layers.

The terms “radiation” and “beam” used herein encompass all types of electromagnetic radiation, including ultraviolet (UV) radiation (e.g., having a wavelength of 365, 248, 193, 157 or 126 nm) and extreme ultra-violet (EUV) radiation (e.g., having a wavelength in the range of 5-20 nm), as well as particle beams, such as ion beams or electron beams.

The term “patterning device” used herein should be broadly interpreted as referring to a device that can be used to impart a projection beam with a pattern in its cross-section such as to create a pattern in a target portion of the substrate. It should be noted that the pattern imparted to the beam of radiation may not exactly correspond to the desired pattern in the target portion of the substrate. Generally, the pattern imparted to the beam of radiation will correspond to a particular functional layer in a device being created in the target portion, such as an integrated circuit.

Patterning devices may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions; in this manner, the reflected beam is patterned. In each example of patterning device, the support structure may be a frame or table, for example, which may be fixed or movable as required and which may ensure that the patterning device is at a desired position, for example with respect to the projection system. Any use of the terms “reticle” or “mask” herein may be considered synonymous with the more general term “patterning device.”

The term “projection system” used herein should be broadly interpreted as encompassing various types of projection systems, including refractive optical systems, reflective optical systems, and catadioptric optical systems, as appropriate for example for the exposure radiation being used, or for other factors such as the use of an immersion fluid or the use of a vacuum. Any use of the term “lens” herein may be considered as synonymous with the more general term “projection system”.

The illumination system may also encompass various types of optical components, including refractive, reflective, and catadioptric optical components for directing, shaping, or controlling the beam of radiation, and such components may also be referred to below, collectively or singularly, as a “lens.”

The lithographic apparatus may be of a type having two (dual stage) or more substrate tables or substrate supports (and/or two or more mask tables). In such “multiple stage” machines the additional tables may be used in parallel, or preparatory steps may be carried out on one or more tables or supports while one or more other tables or supports are being used for exposure. The lithographic apparatus may also be of a type wherein the substrate is immersed in a liquid having a relatively high refractive index, e.g., water, so as to fill a space between the final element of the projection system and the substrate. Immersion liquids may also be applied to other spaces in the lithographic apparatus, for example, between the mask and the first element of the projection system. Immersion techniques are well known in the art for increasing the numerical aperture of projection systems.

While the disclosure has been described with reference to the certain illustrated embodiments, the words that have been used herein are words of description, rather than words of limitation. Changes may be made, within the purview of the associated claims, without departing from the scope and spirit of the disclosure in its aspects. Although the disclosure has been described herein with reference to particular structures, acts, and materials, the disclosure is not to be limited to the particulars disclosed, but rather can be embodied in a wide variety of forms, some of which may be quite different from those of the disclosed embodiments, and extends to all equivalent structures, acts, and, materials, such as are within the scope of the associated claims.

For example, embodiments of the disclosure also include circuits having one or more arrays of logic elements (e.g., microprocessors, ASICs, FPGAs, or similar devices) configured to embody an apparatus as described herein and/or to perform a method as described herein. Embodiments of the disclosure also include data storage media (e.g., semiconductor memory (volatile or nonvolatile; SRAM, DRAM, ROM, PROM, flash RAM, etc.), magnetic or optical disks, etc.) storing one or more sets (e.g., sequences) of machine-executable instructions for performing such a method (or portion thereof).

What is claimed is:

1. An apparatus, comprising:
a controller configured so that, during use of the apparatus when a substrate is present in the apparatus, the controller controls a radiation dose of a beam of radiation impinging on the substrate in response to a critical dimension error, at a plane of the substrate, due to a spatial variation in polarization of the beam of radiation,
wherein the apparatus is a lithographic projection apparatus.

2. The apparatus of claim 1, further comprising:
an illumination system configured to condition the beam of radiation during use of the apparatus; and
a projection system configured so that, during use of the apparatus when the substrate is present and a patterning device is present between the illumination system and the projection system along a path of the beam of radiation through the apparatus, the projection system projects the beam of radiation onto a target portion of the substrate after the beam of radiation interacts with the patterning device.

3. The apparatus of claim 2, further comprising:
a first object table configured to hold the patterning device; and
a second object table configured to hold the substrate.

4. The apparatus as in claim 1, further comprising a detector configured to measure the critical dimension error at a plane of the substrate.

5. The apparatus as in claim 1, wherein the controller is configured to control a source of the beam of radiation.

6. The apparatus as in claim 1, further comprising a variable shutter configured to control a width of a scanning illumination beam during use of the apparatus, wherein the controller is configured to control the variable shutter.

7. The apparatus as in claim 1, further comprising a variable filter configured to locally adjust illumination intensity in the beam of radiation during use of the apparatus, wherein the controller is configured to control the variable filter.

8. The apparatus as in claim 7, wherein the apparatus is designed to hold a patterning device at a plane within the apparatus, and the variable filter is positioned at or proximate the plane or a conjugate plane thereof.

9. The apparatus as in claim 7, wherein the variable filter is controllable so that during use of the apparatus when the substrate is present and a scan is being performed, the variable filter dynamically varies the dose of the radiation beam that impinges on the substrate.

10. The apparatus as in claim 7, wherein the variable filter is configured to be controllable prior to imaging and static during imaging.

11. The apparatus as in claim 7, wherein the variable filter comprises a plurality of fingers, each finger having a coefficient of transmission that is less than 1 for a wavelength of the beam of radiation, and each finger being moveable into and out of the beam of radiation to locally attenuate an intensity of the beam of radiation.

12. The apparatus as in claim 11, wherein the plurality of fingers comprises a first set of fingers positioned proximate a first edge of a scan region and a second set of fingers proximate a second edge of the scan region that is opposed to the first edge of the scan region such that, during use of the apparatus when the substrate is present, the sets of fingers may be used in combination to locally control a dose of radiation at the substrate.

13. The apparatus as in claim 7, wherein the variable filter comprises at least one filter having a coefficient of transmission that is less than 1 for a wavelength of the beam of radiation, and the filter is moveable into and out of the beam of radiation to locally attenuate an intensity of the beam of radiation.

14. The apparatus as in claim 13, wherein the at least one filter comprises a plurality of angled projections, and the at least one filter is positioned proximate an edge of a scan region such that as the filter is moved into the scan region, a greater portion of the scan region is subject to attenuation, and such that a percentage of attenuation is largest at the edge of the scan region.

15. A method, comprising:
patterning a beam of radiation with a patterning device having birefringence;
after patterning the beam of radiation, projecting the beam of radiation onto a radiation sensitive surface of a substrate; and
adjusting a dose of the beam of radiation received at the radiation sensitive surface of the substrate to reduce a critical dimension variation caused by the birefringence.

16. The method according to claim 15, wherein adjusting further comprises locally filtering the beam of radiation to reduce the received dose at least one selected position on the substrate.

17. The method according to claim 16, wherein local filtering is performed at or proximate a plane of the patterning device, or a conjugate plane thereof.

18. The method according to claim 16, wherein local filtering is performed at or proximate a plane of the substrate.

19. The method according to claim 16, further comprising:
relatively scanning the patterning device and the substrate; and
moving at least one filter member into a portion of the beam of radiation while scanning to dynamically adjust the dose of radiation received by the radiation sensitive surface of the substrate.

20. The method according to claim 16, further comprising moving one or more of a plurality of fingers into a portion of the beam of radiation while scanning the beam of radiation to adjust the dose of radiation received by the radiation sensitive surface of the substrate.

21. The method according to claim 16, further comprising moving at least one filter member into a portion of the beam of radiation to adjust the dose of radiation received by the radiation sensitive surface of the substrate.

22. An apparatus, comprising:
an illumination system configured to condition a beam of radiation during use of the apparatus, the illumination system comprising an optical element;
an actuator configured so that, when a substrate is present in the apparatus, the actuator can decenter the optical element of the illumination system in response to a measured critical dimension error, at a plane of the substrate, resulting from a local variation in intensity of the beam of radiation prior to a patterning process,
wherein the apparatus is a lithographic projection apparatus.

23. The apparatus of claim 22, further comprising a projection system configured so that, during use of the apparatus when the substrate is present and a patterning device is present between the illumination system and the projection system along a path of the beam of radiation through the apparatus, the projection system projects the beam of radiation onto a target portion of the substrate after the beam of radiation interacts with the patterning device.

24. The apparatus of claim 23, further comprising:
a first object table configured to hold a patterning device capable of patterning the beam of radiation according to a desired pattern; and
a second object table configured to hold the substrate.

25. Apparatus as in claim 22, further comprising an illumination monitor configured to measure a local variation in intensity of the beam of radiation, prior to patterning.

26. Apparatus as in claim 22, further comprising a variable attenuator comprising a plurality of moveable attenuators, positioned to be movable in or proximate a pupil plane of the illumination system, or a conjugate plane thereof, to attenuate at least a portion of the beam of radiation thereby locally adjusting an illumination distribution thereof.

27. Apparatus as in claim 26, wherein the moveable attenuators comprise a plurality of triangular spokes, moveable into and out of the beam of radiation.

28. Apparatus as in claim 27, wherein the spokes are arranged radially around the beam of radiation.

29. Apparatus as in claim 23, wherein the actuator is configured to move the optical element in a direction perpendicular to an optical axis of the projection system.

30. Apparatus as in claim 22, wherein the actuator is configured to tilt the optical element.

31. A method, comprising:
using a lithographic projection apparatus to project a patterned beam of radiation onto a radiation sensitive surface of a substrate; and
decentering at least one optical element of an illumination system of the lithographic projection apparatus to locally adjust a spatial intensity distribution of the beam of radiation such that a critical dimension error is reduced.

32. A method as in claim 31, further comprising measuring the critical dimension error, at a plane of the substrate.

33. A method as in claim 31, wherein decentering comprises moving the at least one optical element in a direction perpendicular to an optical axis of the illumination system.

34. A method as in claim 31, wherein decentering comprises tilting the at least one optical element.

35. A method as in claim 31, further comprising variably attenuating at least a portion of the beam of radiation thereby locally adjusting an illumination intensity thereof.
